(19) United States
(12) Patent Application Publication
(10) Pub. No.: US 2026/0219801 A1
(43) Pub. Date: Jul. 30, 2026

(54) Efficient TLP Management in FLIT Mode

(71) Applicant: Sandisk Technologies, Inc., Milpitas, CA (US)

(72) Inventor: Shay BENISTY, Beer Sheva (IL)

(73) Assignee: Sandisk Technologies, Inc., Milpitas, CA (US)

(21) Appl. No.: 19/040,415

(22) Filed: Jan. 29, 2025

(51) Int. Cl. G06F 3/06

(52) U.S. Cl. CPC G06F 3/0655; G06F 3/0604; G06F 3/0679

(57) ABSTRACT

Flow control units (FLITs) are constrained by not allowing more than eight transaction layer packets (TLPs) within two, specific ranges. Multiple short TLPs may not fill an entire range and thus the range will need to be filled with no operation (NOP) TLPs. NOP TLPs are likely needed when multiple short TLPs are present in the FLIT. Taking the TLPs out of order solves the issue, or at least minimizes the number of NOP TLPs in the FLIT, by inserting longer TLPs into the FLIT. The TLPs taken out of order can be arranged so that a minimum amount of or even no NOP TLPs are in the FLIT. If there are not sufficient TLPs to fill the FLIT, then the FLIT will eventually be sent regardless of the number of NOP TLPs, but when there are numerous TLPs, reordering optimizes data transmission.

### BACKGROUND OF THE DISCLOSURE

### Field of the Disclosure

Embodiments of the present disclosure generally relate to optimizing FLIT mode data transmission.

### Description of the Related Art

The peripheral component interconnect (PCI) express (PCIe) 6.0 specification uses flow control unit (FLIT) encoding, which enables the specification to provide low latency with high efficiency. Error correction needs to operate on fixed sized packets, which is why FLIT is adopted for PCIe 6.0 architecture. Since error correction happens on FLIT, the CRC is checked as well as retry at the FLIT level. Once the link operates in FLIT mode, any speed change to lower data rates will also have to use the same FLIT mode. Thus, once enabled, FLIT mode is followed in the link, irrespective of the speed. The FLIT mode is a significant departure for the PCIe 6.0 specification, and the improved bandwidth that results from low overhead amortization allows for high bandwidth efficiency, low latency and reduced area.

The size of the FLIT packet is fixed at 256 bytes. The FLIT contains 236 bytes of transaction layer packets (TLPs), 6 bytes of data link packets (DLPs), 8 bytes of cyclic redundancy check (CRC), and 6 bytes of error correction code (ECC). DLP can be startup packets, end of a packet, credits passed between links, etc. FLITs are sent one after the other. For example, FLIT 1 is sent followed by FLIT 2, and so on. Each FLIT can be called an atomic packet. If there are errors in the FLIT, the controller will be able to detect the errors because of the CRC.

As FLITs are new, efficiently sending FLITs is a new challenge Therefore, there is a need in the art for efficient FLIT transmissions.

### SUMMARY OF THE DISCLOSURE

Flow control units (FLITs) are constrained by not allowing more than eight transaction layer packets (TLPs) within two, specific ranges. Multiple short TLPs may not fill an entire range and thus the range will need to be filled with no operation (NOP) TLPs. NOP TLPs are likely needed when multiple short TLPs are present in the FLIT. Taking the TLPs out of order solves the issue, or at least minimizes the number of NOP TLPs in the FLIT, by inserting longer TLPs into the FLIT. The TLPs taken out of order can be arranged so that a minimum amount of or even no NOP TLPs are in the FLIT. If there are not sufficient TLPs to fill the FLIT, then the FLIT will eventually be sent regardless of the number of NOP TLPs, but when there are numerous TLPs, reordering optimizes data transmission.

In one embodiment, a data storage device comprises: a memory device; and a controller coupled to the memory device, wherein the controller is configured to: detect a burst of a first plurality of transaction layer packets (TLPs) that if transmitted in order would need one or more no operation (NOP) TLPs added thereto; reorder the first plurality of TLPs into a first group of TLPs for a first portion of a flow control unit (FLIT), wherein the first portion having the first group contains fewer available bytes compared to the burst; determine whether there is at least one available byte in the first portion of the FLIT after the reordering; and add one or more first NOP TLPs to the first portion of the FLIT if the determining results in at least one available byte in the first portion of the FLIT.

In another embodiment, a data storage device comprises: a memory device; and a controller coupled to the memory device, wherein the controller is configured to: receive TLPs in a first order; reorder the TLPs into a second order that is different from the first order; place the reordered TLPs into a FLIT; and send the FLIT to a host device.

In another embodiment, a data storage device comprises: means for storing data; and a controller coupled to the means for storing data, wherein the controller is configured to: keep track of a FLIT boundary for a FLIT; perform packet arbitration by reordering packets for the FLIT; determine whether one or more NOP TLPs need to be added to the FLIT; assemble the FLIT with the reordered packets; and send the FLIT to a host device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIGS. 2A-2C are a schematic illustration of a flow control unit (FLIT) packet structure in a four lane configuration.

FIGS. 3A-3B are a schematic illustration of a FLIT packet example with a maximum number of eight transaction layer packets (TLPs) in a half of a FLIT.

FIG. 4 is schematic illustration comparing the previous approach to the new approach for TLP sending.

FIG. 5 is a flowchart illustrating a transaction scheduler in FLIT mode according to one embodiment.

FIG. 6 is schematic illustration of a data storage system according to one embodiment.

FIG. 7 is a flowchart illustrating FLIT creation according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Flow control units (FLITs) are constrained by not allowing more than eight transaction layer packets (TLPs) within two, specific ranges. Multiple short TLPs may not fill an entire range and thus the range will need to be filled with no operation (NOP) TLPs. NOP TLPs are likely needed when multiple short TLPs are present in the FLIT. Taking the TLPs out of order solves the issue, or at least minimizes the number of NOP TLPs in the FLIT, by inserting longer TLPs into the FLIT. The TLPs taken out of order can be arranged so that a minimum amount of or even no NOP TLPs are in the FLIT. If there are not sufficient TLPs to fill the FLIT, then the FLIT will eventually be sent regardless of the number of NOP TLPs, but when there are numerous TLPs, reordering optimizes data transmission.

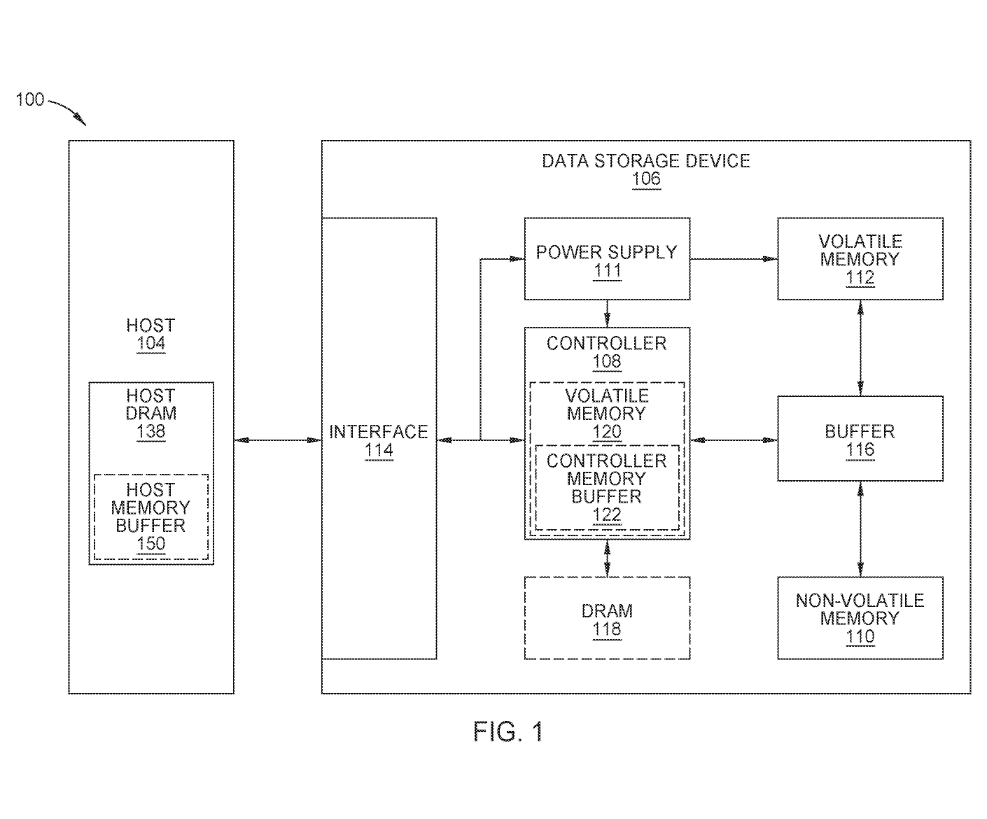

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

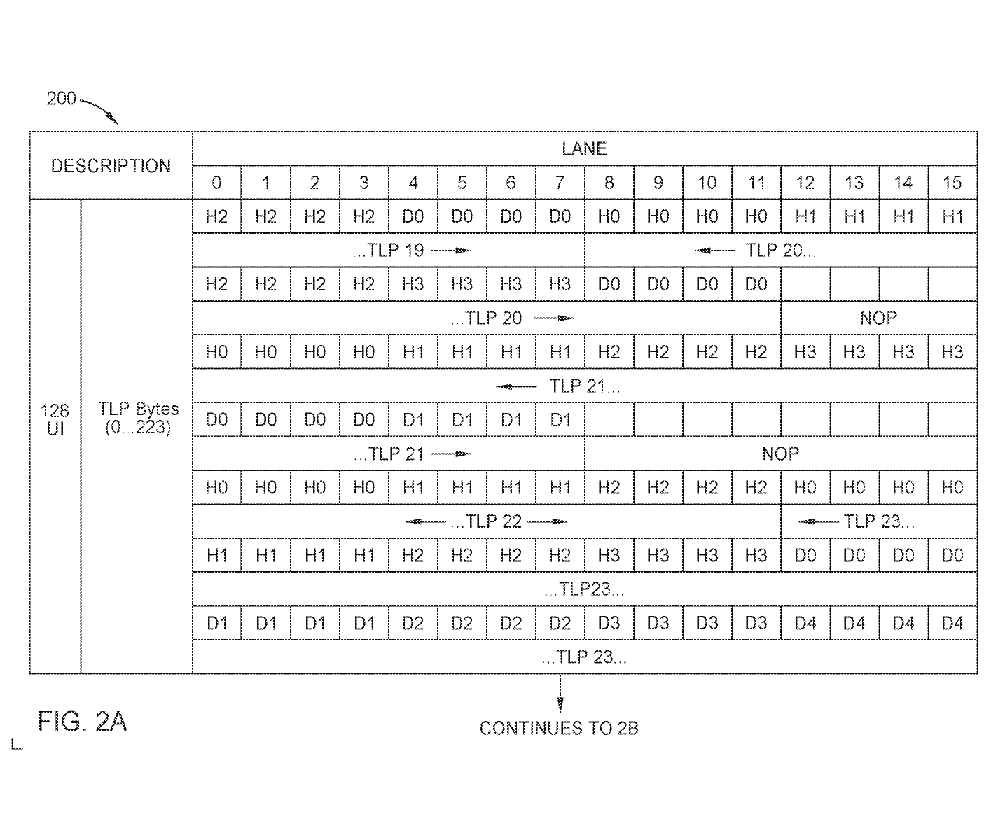

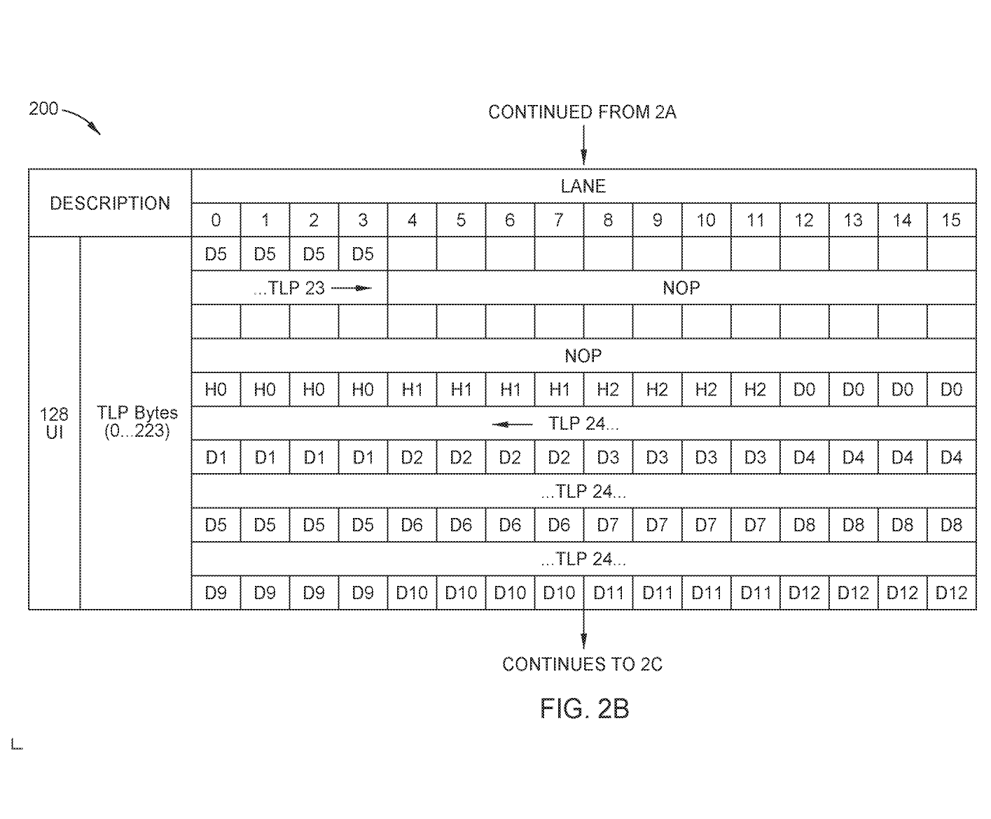

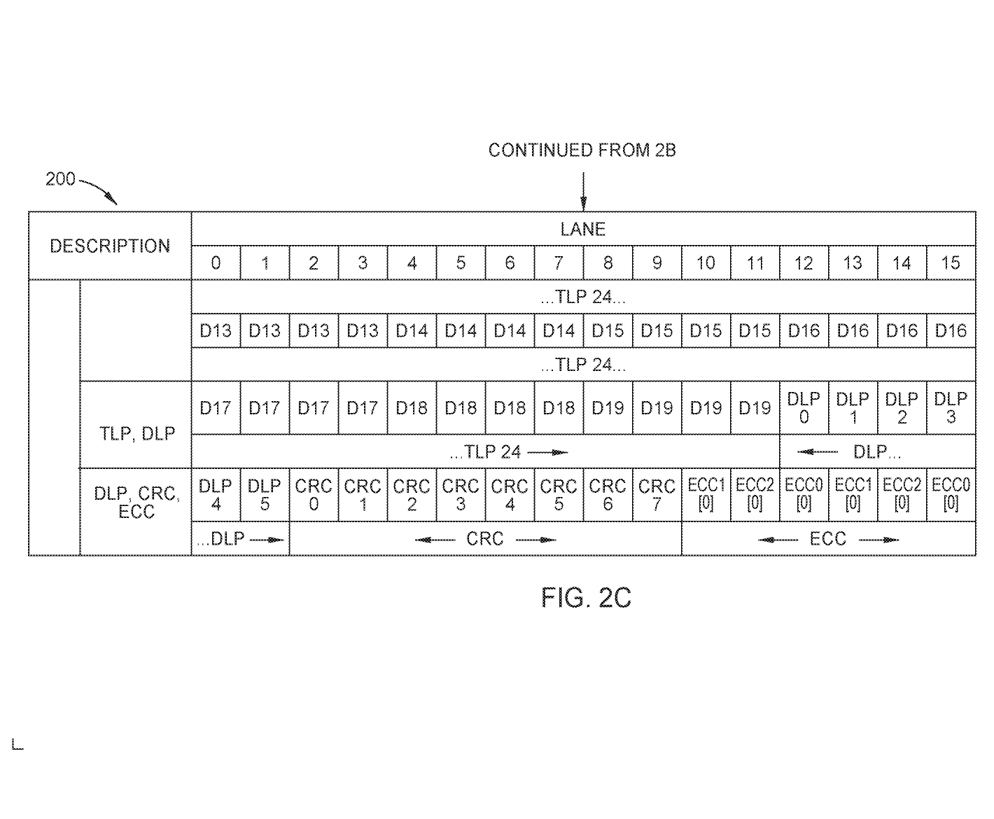

FIGS. 2A-2C are a schematic illustration of a FLIT packet structure 200 in a sixteen lane configuration. As can be see, the FLIT consists of 236-bytes of TLPs, 6-bytes of DLP, 8-bytes of CRC and 6-bytes of ECC. The FLIT also presents an example of TLP placement. The FLIT starts with a continuation of the remaining 2 dwords (DWs) from TLP 19. TLP 20 immediately starts in lane 8 and ends in lane 11. Since the transmitter has nothing to send, the transmitter sends NOP until the 4 DW aligned boundary, which is in lane 15. TLPs 22 and 23 are scheduled without any intervening NOP. After TLP 23, the transmitter did not have anything to send and thus sent 7 NOPs, aligned to a 4 DW boundary until TLP 24 is ready, which continues until the FLIT boundary for TLP bytes. After that there are 6 bytes of DLP, 8 bytes of CRC covering the 236 bytes of TLP and 6 bytes of DLP in the FLIT; and 3 sets of interleaved ECC, 2 bytes each, covering the entire 256 byte FLIT.

PCIe standards define some rules to be applied for the non-NOP TLPs in bytes 0 through 127 of the FLIT (i.e., the TLP bytes within the first FLIT half) and bytes 128 through 235 of the FLIT (i.e., the TLP bytes within the second FLIT half). One of the rules is that no more than 8 non-NOP TLPs, including partial TLPs, can be held in those bytes. Receivers are permitted to check the rule and if checked, logged as a data link protocol error in the receiving port if there are more than 8 non-NOP TLPs. The rule thus imposes a constraint on the transmitter. When the transmitter encounters this scenario, the transmitter must insert NOP-TLPs to ensure compliance with the rule. However, sending NOP-TLPs alongside other packets reduces performance and efficiency over the link. The NOP TLPs reduce performance because for NOPs, data is sent over the link interface with no meaning, but the NOP still needs to be sent when there is no non-NOP TLPs to send or the maximum of eight non-NOP TLPs are already in the range for the FLIT. For each range, the size of the TLP is not fixed. Thus, when having small TLPs one after the other the NOP will need to be inserted because of the small non-NOP TLPs. However, if there are long TLPs, the non-NOP TLP constraint will not be an issue. The disclosure addresses the constraint imposed by this rule on the FLITs and presents a method to overcome this constraint without sacrificing performance and efficiency.

The disclosure presents a scheduling method at the application layer that takes into account the FLIT mode and corresponding boundaries over the link. The scheduler strategically selects the next packet for transmission to minimize the occurrence of NOP packets, optimizing data transmission. By interspersing small TLP bursts with longer TLPs, the scheduling enhances efficiency and overall system performance.

PCIe TLPs without payload typically consist of headers only, without any accompanying data payload. The packets are used for various control and management functions within the PCIe protocol. The packets are very small (12-16 bytes) and will easily encounter the FLIT constraint. Example PCIe TLPs include PCIe Completion TLP, PCIe Configuration Read TLP, PCIe Configuration Write TLP, and PCIe Message TLP.

PCIe Completion TLP is a type of TLP used to communicate completion status for PCIe transactions and contains header information indicating completion status, without any data payload. PCIe Configuration Read TLP is for when a device needs to read configuration data from another device on the PCIe bus, and the packet includes only header information specifying the configuration read request, without any payload. PCIe Configuration Write TLP is similar to the PCIe Configuration Read TLP, but is used to write configuration data to another device on the PCIe bus and includes header information indicating the configuration write request, without payload. For PCIe Message TLP, PCIe supports various types of message transactions for communication between devices such as flow control credit messages, link management messages, and error reporting messages. The message TLPs typically consist of header information relevant to the specific message type, without payload. The aforementioned TLPs are just a few examples of PCIe TLPs without payload. Each PCIe TLP serves a specific purpose within the PCIe protocol for control, management, or signaling functions.

The idea is to reorder the TLPs in order to avoid or at least minimize sending NOP TLPs in the FLIT. Taking a step back, short packets are packets with a packet size of up to 16 bytes. When there are multiple short packets, the FLIT will easily encounter the constraints.

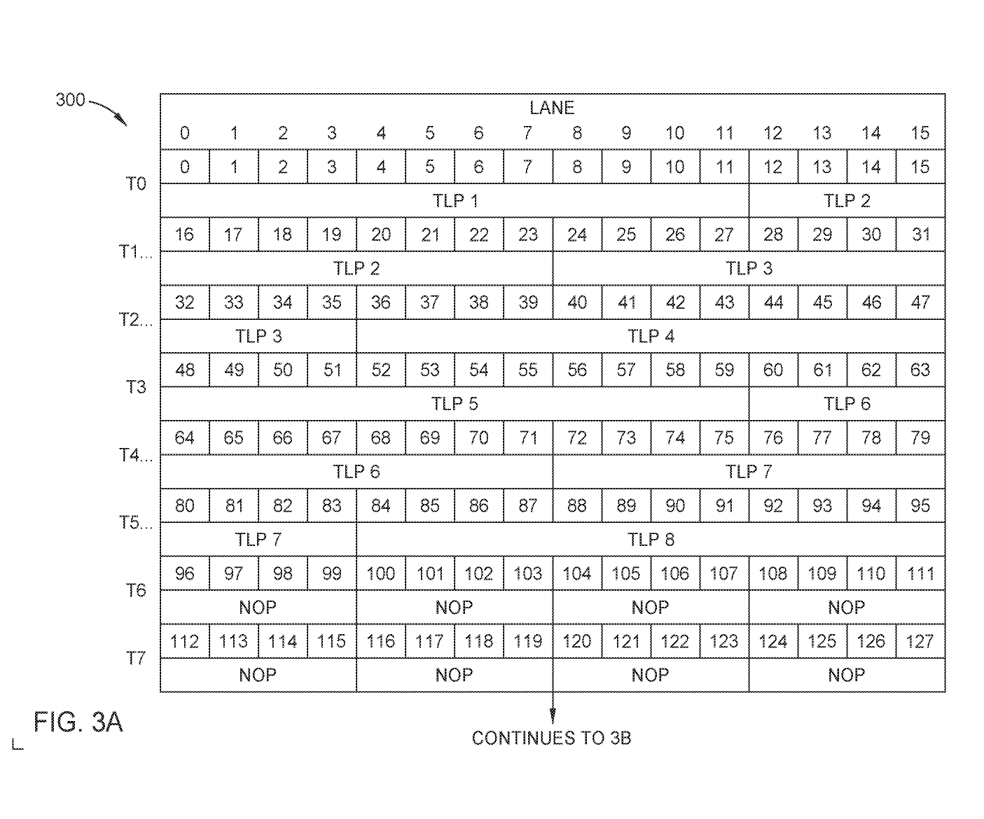

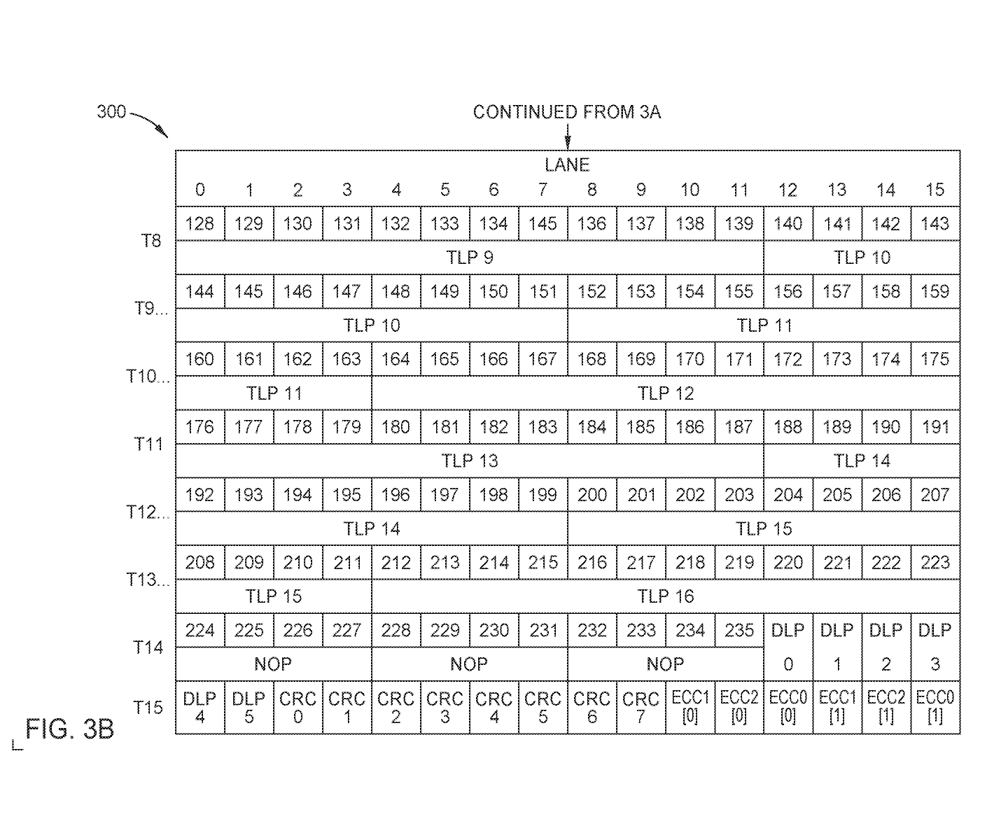

FIGS. 3A-3B are a schematic illustration of a FLIT packet 300 example with a maximum number of eight TLPs in a half of a FLIT. FIGS. 3A-3B show one example when the FLIT has to include NOP-TLPs due to reaching the maximum number of allowed non-NOP TLPs in the FLIT. As can be seen, the FLIT holds small TLPs, e.g. memory read transactions while the size of each is 12-bytes. T6, T7, and T14 must hold NOP-TLPs in the scenario which reduces the efficiency of the FLIT and the overall performance.

More specifically with regards to FIGS. 3A-3B, the FLIT has TLP 1 with 12 bytes, TLP 2 with 12 bytes, and so on. After TLP 8, the constraints begin. No additional TLPs can be sent because according to the standard the FLIT must now have no more non-NOP TLP packets up through byte 128. Thereafter, the FLIT can include non-NOP TLPs 9-16 where again the constraint is reached after which NOP TLPs will be sent in the FLIT before reaching the DLP. Such a FLIT is not good and will reduce the efficiency and the performance.

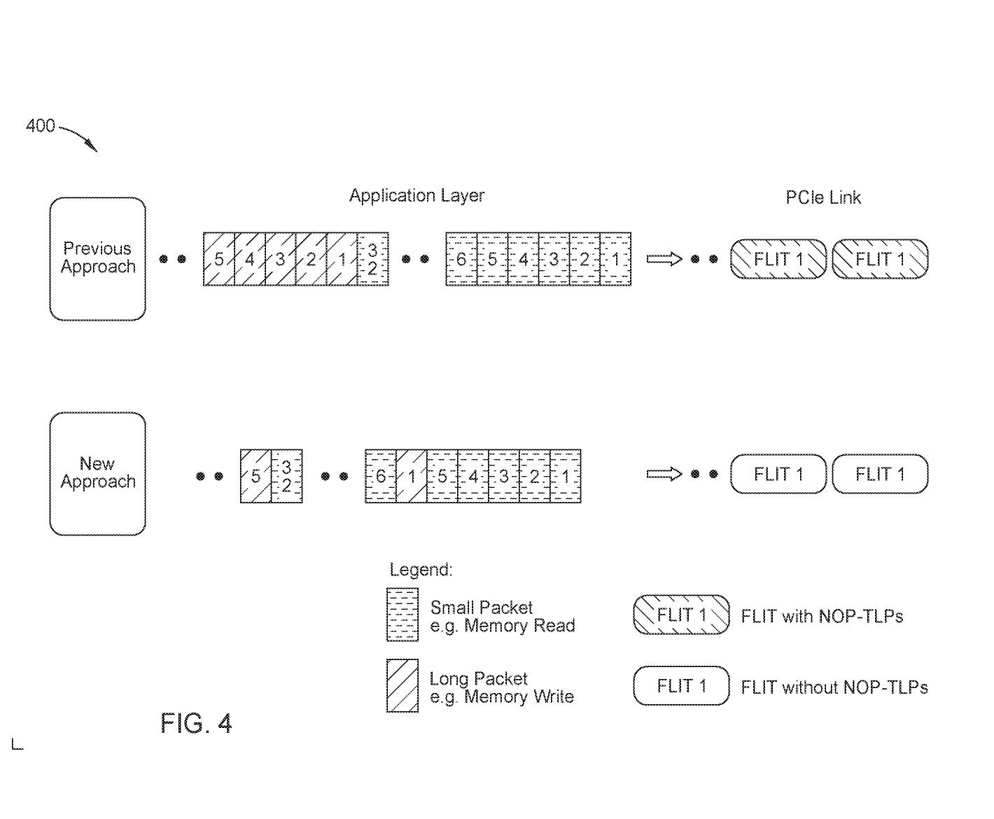

FIG. 4 is schematic illustration 400 comparing the previous approach to the new approach for TLP sending. FIG. 4 presents the difference between the previous approach and the new one. In the previous approach, when the device controller needs to read 4KB from the host, the controller needs to send 32 memory read request of 12-bytes (when PCIe Max Read Request Size is 128-bytes). When sending those requests one after the other, the transaction layer will have to insert NOP-TLPs in the FLITs due to reaching the max number of TLPs in a half of FLIT. The new approach takes that into account in the application layer when generating the requests. The application later sends other longer packets in the middle of this burst to optimize the efficiency and performance of the link.

The previous approach shown in FIG. 4 illustrates a lot of TLPs just before sending the TLPs over the PCI link. There are small packets 1 to 32 and long packets 1 to 5. In the previous approach, the packets are simply sent in order in the order added in the system. Thus, first the short packets are sent and only after completing sending the short packets, the long packets are sent. The result is an inefficient FLIT because the FLIT will have some NOP TLPs because of the constraints.

In the new approach, the packets are reordered to avoid NOP TLPs in the FLIT. Avoiding NOP TLPs in the FLIT occurs by sending the short packets initially and then reordering the packets thereafter to select other packets which are longer. In so doing, no or fewer NOP TLPs will be present in the FLIT and thus, the FLIT will be more efficient. Generally speaking, reordering the internal packets that to maximize the performance and efficiency of the link due to the FLIT restriction.

More specifically as shown in FIG. 4, the PCIe link and application layer are shown for both a previous approach and the new approach discussed herein. Each FLIT will be as discussed above with 236 bytes of TLPs, 6 bytes of DLP, 8 bytes of CRC, and 6 bytes of ECC. The discussion with regards to the FLITs for FIG. 4 will focus on the 236 bytes of TLP. The PCIe link simply shows two FLITs for both the previous approach and the new approach. The application layer is where the difference occurs. In general, the application layer shows both small packets and long packets where small packets are up to 16 bytes while long packets are over 16 bytes. In both the previous approach and the new approach, there are 32 small packets and some unknown number of long packets with up to 5 long packets shown. For exemplification purposes, assume that each small packet is 12 bytes long and each long packet is 20 bytes long. Also for exemplification purposes assume that there are 5 total long packets and 32 total small packets. Keep in mind the constraints for the FLITs: no more than eight non-NOP TLPs in bytes 0-127 and no more than eight non-NOP TLPs in bytes 128-235.

For the old approach, eight small packets at 12 bytes a piece will result in 96 bytes of bytes 0-127 used for non-NOP TLPs and the remaining 32 bytes filled with NOP TLPs. Eight small packets at 12 bytes a piece will result in 96 bytes of bytes 128-235 used for non-NOP TLPs and the remaining 12 bytes filled with NOP TLPs. To send all of the small packets in order, it will take 2 FLITs in total with 88 wasted bytes (44 per FLIT) of NOP TLP. The longer packets would be sent in the third FLIT where bytes 0-99 would contain all of the long packets (five total) and the third FLIT would have room for up to 3 packets in bytes 100-127 (28 remaining) and then up to 8 packets in bytes 128-235...else fill bytes 100-235 with NOP TLPs. In total, assuming bytes 100-235 can be filled with non-NOP TLPs, the three FLITs send 88 total bytes of NOP TLP. If assumed that bytes 100-235 cannot be filed with non-NOP TLPs, then 224 bytes of NOP TLP are sent in just three FLITs...almost an entire FLIT collectively is wasted.

For the new approach, re-ordering the packets will make a difference. For example, if six small packets at 12 bytes a piece and two long packets at 20 bytes a piece are sent for bytes 0-127 in the first FLIT, then bytes 0-111 would be filed, and bytes 112-127 (a total of 16 bytes) would have NOP TLPs. Then, if five small packets are used at 12 bytes a piece and two long packets at 20 bytes a piece are used for bytes 128-235, then bytes 128-227 would be filed and bytes 228-235 (a total of 8) bytes would have NOP TLPs to complete the first FLIT with a total of 24 NOP TLPs in the first FLIT. The second FLIT could contain seven short packets and one long packet for bytes 0-103 leaving bytes 104-127 (a total of 24) for NOP TLP. Eight small packets at 12 bytes a piece will result in 96 bytes of bytes 128-235 used for non-NOP TLPs and the remaining 12 bytes filled with NOP TLPs to complete the second FLIT with 36 total NOP TLPs at which point all long packets are sent and 26 total small packets have been sent. For the third FLIT, six small packets can be sent for bytes 0-71 with the remaining bytes 72-235 available for more non-NOP TLP packets...else fill bytes 72-235 with NOP TLPs. In total, assuming bytes 72-235 can be filled with non-NOP TLPs, the three FLITs send 60 bytes of NOP TLP, which is significantly better (i.e., 28 bytes better) than the previous approach. If assumed that bytes 72-235 cannot be filed with non-NOP TLPs, then 224 bytes of NOP TLP are sent in just three FLITs, which is less than an entire FLIT and identical to the previous method. Hence, assuming bytes can be filled, the new approach where reordering occurs results in less NOP TLPs in FLITs

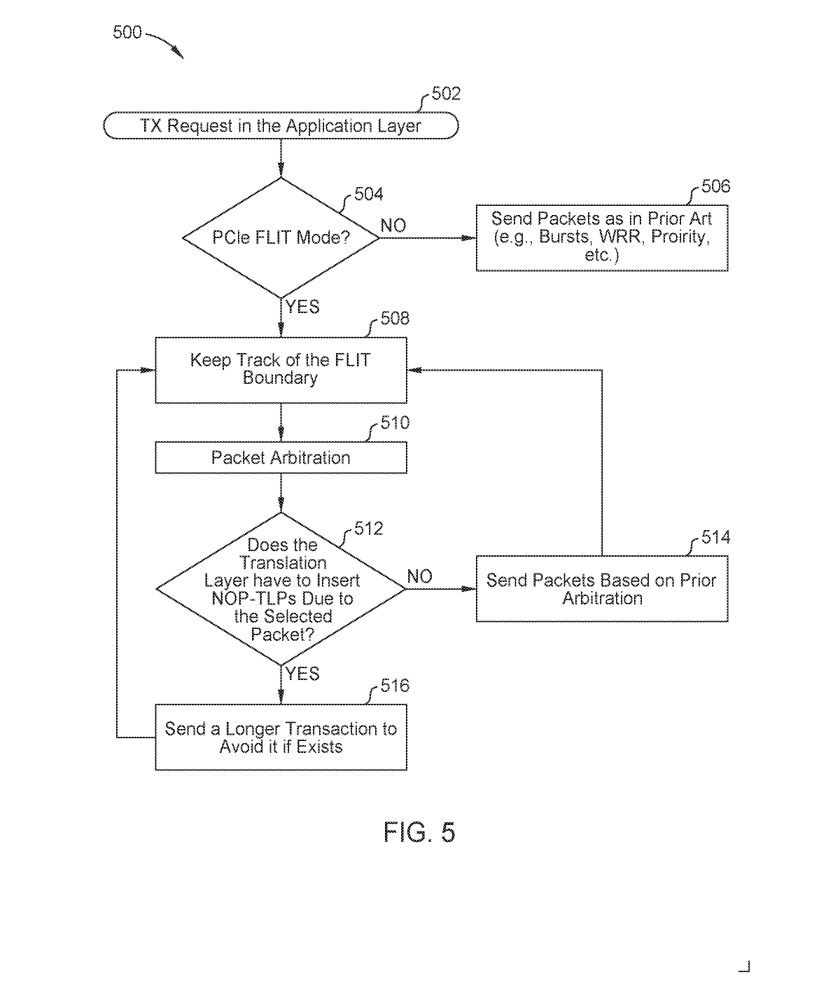

FIG. 5 is a flowchart 500 illustrating a transaction scheduler in FLIT mode according to one embodiment. FIG. 5 presents the algorithm implemented in the application layer of the SSD to avoid entering the scenarios of enforcing to send NOP-TLPs while having pending packets. In non-FLIT mode, the scheduler can work as previously (i.e., using priority scheme, WRR and burst awareness). However, when working in FLIT mode, the boundary of the FLIT is considered even in the application layer to avoid entering the scenario of enforcing to send NOP-TLPs while having pending packets. The avoiding is done by adding longer packets even in a burst of small packets.

In FIG. 5, the transmit (TX) scheduler receives a request in the application layer and there is a desire to send something over the link. First, the controller checks if the data storage device is in PCIe FLIT mode. If not in PCIe FLIT mode, the data storage device will continue using previous methods such as bursts, WRR, priority, etc. If PCIe FLIT mode is enabled, then the controller will keep track of the FLIT boundary. In most cases in PCIe Gen 6, FLIT mode would be enabled because PCIe FLIT mode will increase the performance and all the attributes of FLIT mode are enabled. Thereafter packet arbitration occurs based on the packet arbitration in considering the constraint on the rule that is defined in the standard. Based on the packet arbitration, the controller may reorder the packets in order to avoid the scenario where NOPs are sent in the FLIT in order to be aligned with the standard.

More specifically with regards to FIG. 5, there is a TX request in the application layer at block 502 followed by a determination at block 504 regarding whether the data storage device is operating in PCIe FLIT mode. If not operating in PCIe FLIT mode, then at block 506 packets are sent as in the previous known manner such as by bursts, weighted round robin (WRR), priority, etc. If operating in PCIe FLIT mode, then the controller keeps track of the FLIT boundary at block 508 and packet arbitration occurs as block 510. Blocks 508 and 510 are performed in the HIM, and the TX arbiter specifically. After packet arbitration, the controller determines if the transaction layer has to insert NOP TLPs due to the selected packet at block 512. If there is no need to insert NOP TLPs, then the packet is sent based upon the prior arbitration at block 514 followed by a return to block 508. If a NOP TLP has to be inserted, then a longer transaction is sent to avoid inserting a NOP TLP at block 516 if a longer transaction exists. Thereafter, the method returns to block 508.

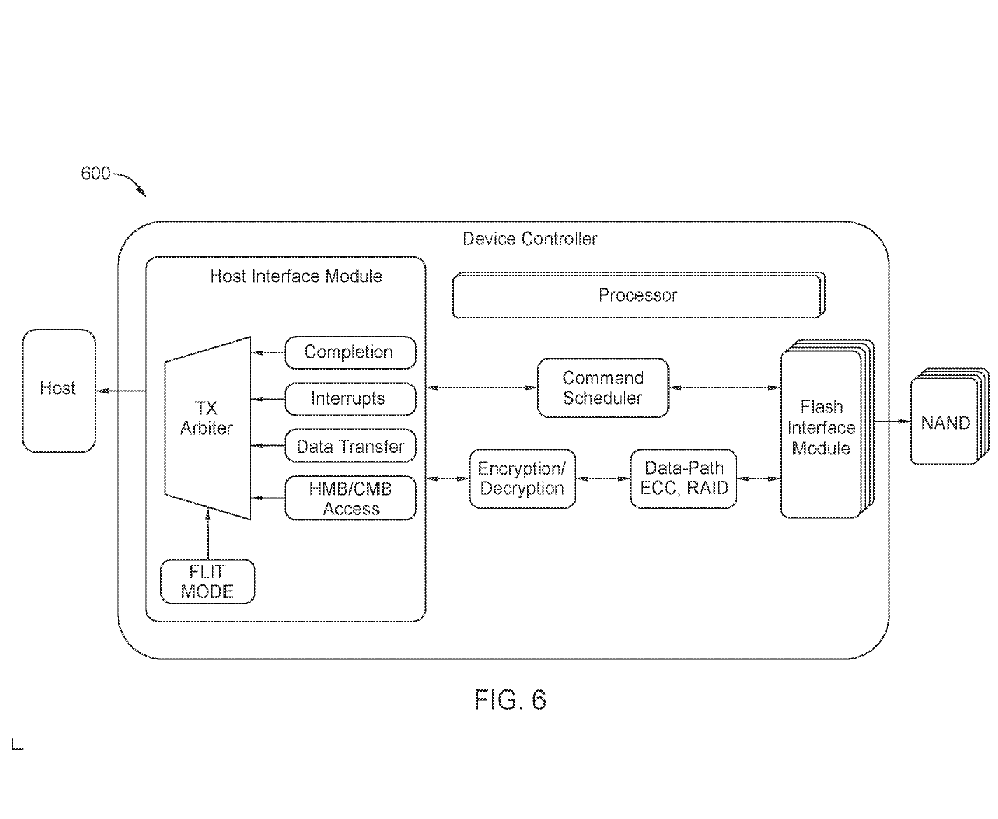

FIG. 6 is schematic illustration of a data storage system 600 according to one embodiment. The device controller incorporates the TX arbiter that considers the FLIT mode and FLIT boundary when scheduling the packets. The focus in FIG. 6 is on the host interface module. There is a TX arbiter and the clients that want to send packets over the link. For example, completion for completion queues the controller needs to post messages to the completion queue. For interrupt, data transfer, and HMB/CMB accesses, the TX arbiter will take into account the constraints of PCIe FLIT mode, and based on the constraints the TX arbiter may decide to reorder the packets in order to maximize the performance and have better efficiencies over the FLIT.

In one embodiment, device controller may behave differently in FLIT and non-FLIT mode while in other embodiments, the operation could be the same for both as in FLIT mode. Basically, the controller can do the same thing in FLIT mode and non-FLIT mode, but the controller has the decision on whether to have the same kinds of implementation in non-FLIT mode or not.

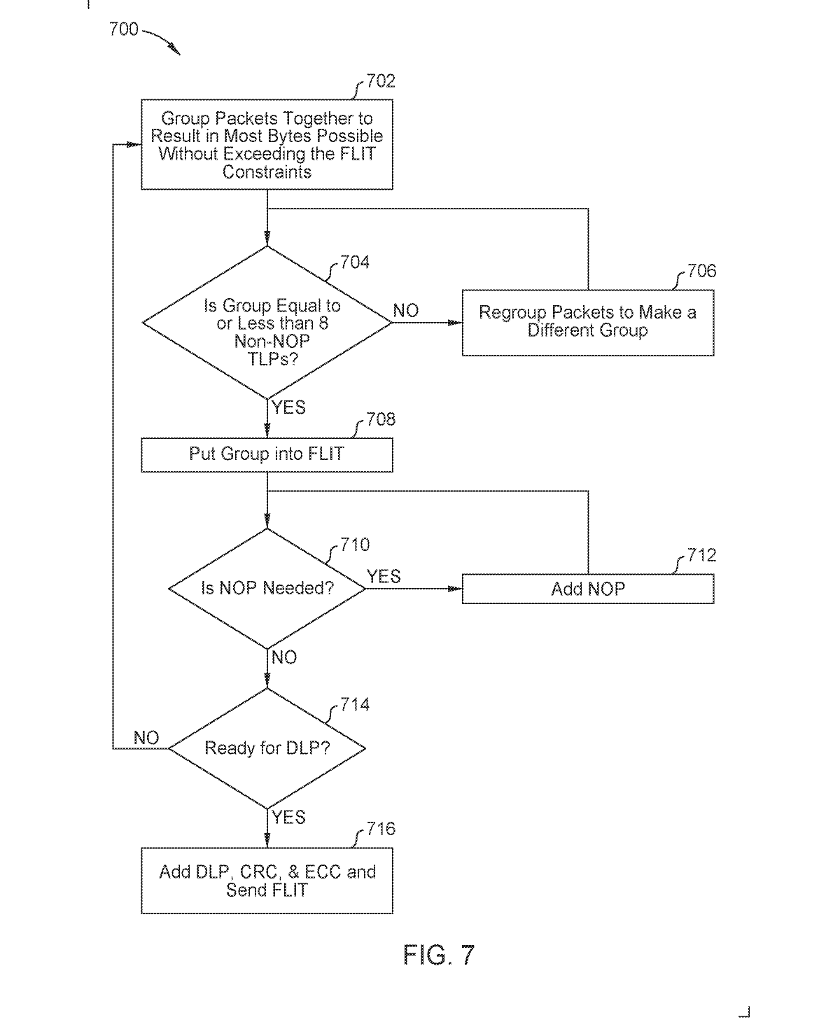

FIG. 7 is a flowchart 700 illustrating FLIT creation according to one embodiment. It is to be noted that one TLP could span several FLITs, depending upon the starting point of the TLP and the size of the TLP. The process involves grouping non-NOP TLP packets together to result in the most bytes possible without exceeding the FLIT constraints at block 702. The FLIT constraints for block 702 are no more than 128 bytes for bytes 0-127 and no more than 108 bytes for bytes 128-235. Thereafter, a determination is made regarding whether the group contains an amount of non-NOP TLPs equal to or less than eight at block 704. It is to be noted that block 704 and 702 can occur simultaneously when beginning the process of making a FLIT. If more than eight non-NOP TLPs, then the packets are reordered and regrouped to make a different group at block 706 and block 704 is repeated. Similarly, it is to be noted that if block 706 is performed, block 704 need not follow block 706, but rather, blocks 706 and 704 may occur simultaneously.

If there are eight or less non-NOP TLPs in the group at block 704, then the packets are placed in a FLIT at block 708. A determination is then made at block 710 regarding whether a NOP TLP is needed for the FLIT. If needed, a NOP TLP is added at block 712 and block 710 is repeated. If no NOP TLP is needed, then a determination is made at block 714 regarding whether the FLIT is ready for DLP. If the FLIT is not ready for DLP, then the process returns to block 702, but if the FLIT is ready for DLP, then the DLP, CRC, and ECC are added to the FLIT, and the FLIT is sent at block 716.

By interspersion of small TLP bursts with longer TLPs, efficiency is enhanced and overall system performance improves. Thus, the disclosure offers benefits by optimizing data transmission over a link.

In one embodiment, a data storage device comprises: a memory device; and a controller coupled to the memory device, wherein the controller is configured to: detect a burst of a first plurality of transaction layer packets (TLPs) that if transmitted in order would need one or more no operation (NOP) TLPs added thereto; reorder the first plurality of TLPs into a first group of TLPs for a first portion of a flow control unit (FLIT), wherein the first portion having the first group contains fewer available bytes compared to the burst; determine whether there is at least one available byte in the first portion of the FLIT after the reordering; and add one or more first NOP TLPs to the first portion of the FLIT if the determining results in at least one available byte in the first portion of the FLIT. The controller is configured to: reorder a second plurality of TLPs into a second group of TLPs for a second portion of the FLIT; determine whether there is at least one available byte in the second portion of the FLIT; and add one or more second NOP TLPs to the second portion of the FLIT if the determining results in at least one available byte in the second portion of the FLIT. A first TLP of the first group of TLPs has a first number of bytes and a second TLP of the first group of TLPs has a second number of bytes different than the first number of bytes. The first number is greater than 12 bytes and the second number if less than 12 bytes. The reordering comprises placing a first TLP into the first group, wherein absent reordering, the first TLP would not be in the first group. The reordering comprises grouping together a plurality of TLPs having different byte lengths. The one or more first NOP TLPs is a plurality of first NOP TLPs and wherein the plurality of first NOP TLPs are adjacent one another in the FLIT. The reordering occurs in a HIM of the controller using a TX arbiter. The controller is configured to handle TLPs differently when operating in FLIT mode compared to handling TLPs in non-FLIT mode. The controller is configured to handle TLPs the same when operating in either FLIT mode or non-FLIT mode.

In another embodiment, a data storage device comprises: a memory device; and a controller coupled to the memory device, wherein the controller is configured to: receive TLPs in a first order; reorder the TLPs into a second order that is different from the first order; place the reordered TLPs into a FLIT; and send the FLIT to a host device. The reordering is performed by an arbiter. The controller is configured to determine whether the data storage device operates in FLIT mode or non-FLIT mode. The controller is configured to determine whether the FLIT is full. The controller is configured to insert one or more NOP TLPs into the FLIT. The reordering comprises determining whether to insert a NOP TLP into the FLIT. The reordering comprises moving a first TLP having a first length ahead of a second TLP having a second length that is less than the first length.

In another embodiment, a data storage device comprises: means for storing data; and a controller coupled to the means for storing data, wherein the controller is configured to: keep track of a FLIT boundary for a FLIT; perform packet arbitration by reordering packets for the FLIT; determine whether one or more NOP TLPs need to be added to the FLIT; assemble the FLIT with the reordered packets; and send the FLIT to a host device. The controller is configured to determine whether the data storage device is operating in PCIe FLIT mode. The controller is configured to add a plurality of NOP TLPs to the FLIT, wherein at least one NOP TLP of the plurality of NOP TLPs is spaced from remaining NOP TLPs by at least one non-NOP TLP.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
detect a burst of a first plurality of transaction layer packets (TLPs) that if transmitted in order would need one or more no operation (NOP) TLPs added thereto;
reorder the first plurality of TLPs into a first group of TLPs for a first portion of a flow control unit (FLIT), wherein the first portion having the first group contains fewer available bytes compared to the burst;
determine whether there is at least one available byte in the first portion of the FLIT after the reordering; and
add one or more first NOP TLPs to the first portion of the FLIT if the determining results in at least one available byte in the first portion of the FLIT.

2. The data storage device of claim 1, wherein the controller is configured to:
reorder a second plurality of TLPs into a second group of TLPs for a second portion of the FLIT;
determine whether there is at least one available byte in the second portion of the FLIT; and
add one or more second NOP TLPs to the second portion of the FLIT if the determining results in at least one available byte in the second portion of the FLIT.

3. The data storage device of claim 1, wherein a first TLP of the first group of TLPs has a first number of bytes and a second TLP of the first group of TLPs has a second number of bytes different than the first number of bytes.

4. The data storage device of claim 3, wherein the first number is greater than 12 bytes and the second number if less than 12 bytes.

5. The data storage device of claim 1, wherein the reordering comprises placing a first TLP into the first group, wherein absent reordering, the first TLP would not be in the first group.

6. The data storage device of claim 1, the reordering comprises grouping together a plurality of TLPs having different byte lengths.

7. The data storage device of claim 1, wherein the one or more first NOP TLPs is a plurality of first NOP TLPs and wherein the plurality of first NOP TLPs are adjacent one another in the FLIT.

8. The data storage device of claim 1, wherein the reordering occurs in a host interface module (HIM) of the controller using a transmit (TX) arbiter.

9. The data storage device of claim 1, wherein the controller is configured to handle TLPs differently when operating in FLIT mode compared to handling TLPs in non-FLIT mode.

10. The data storage device of claim 1, wherein the controller is configured to handle TLPs the same when operating in either FLIT mode or non-FLIT mode.

11. A data storage device, comprising:
a memory device; and
a controller coupled to the memory device, wherein the controller is configured to:
receive transaction layer packets (TLPs) in a first order;
reorder the TLPs into a second order that is different from the first order;
place the reordered TLPs into a flow control unit (FLIT); and
send the FLIT to a host device.

12. The data storage device of claim 11, wherein the reordering is performed by an arbiter.

13. The data storage device of claim 11, wherein the controller is configured to determine whether the data storage device operates in FLIT mode or non-FLIT mode.

14. The data storage device of claim 11, wherein the controller is configured to determine whether the FLIT is full.

15. The data storage device of claim 14, wherein the controller is configured to insert one or more no operation (NOP) TLPs into the FLIT.

16. The data storage device of claim 15, wherein the reordering comprises determining whether to insert a NOP TLP into the FLIT.

17. The data storage device of claim 16, wherein the reordering comprises moving a first TLP having a first length ahead of a second TLP having a second length that is less than the first length.

18. A data storage device, comprising:
means for storing data; and
a controller coupled to the means for storing data, wherein the controller is configured to:
keep track of a flow control unit (FLIT) boundary for a FLIT;
perform packet arbitration by reordering packets for the FLIT;
determine whether one or more no operation (NOP) transaction layer packets (TLPs) need to be added to the FLIT;
assemble the FLIT with the reordered packets; and
send the FLIT to a host device.

19. The data storage device of claim 18, wherein the controller is configured to determine whether the data storage device is operating in peripheral component interconnect (PCI) express (PCIe) FLIT mode.

20. The data storage device of claim 18, wherein the controller is configured to add a plurality of NOP TLPs to the FLIT, wherein at least one NOP TLP of the plurality of NOP TLPs is spaced from remaining NOP TLPs by at least one non-NOP TLP.
